(19) United States
(12) Patent Application Publication
(10) Pub. No.: US 2008/0227682 A1
(43) Pub. Date: Sep. 18, 2008

(54) Acidic Hard Surface Cleaning Compositions

(75) Inventors: James Chi-Cheng Feng, Fort Lee, NJ (US); Dilip Shanker Mathur, East Brunswick, NJ (US); Jeanne Marie Weller, Montvale, NJ (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER INC., Parsippany, NJ (US)

(21) Appl. No.: 11/916,103

(22) PCT Filed: May 16, 2006
(86) PCT No.: PCT/GB2006/001795

§ 371 Date: Mar. 10, 2008

Related U.S. Application Data
(60) Provisional application No. 60/688,065, filed on Jun. 7, 2005.

(30) Foreign Application Priority Data
Jan. 19, 2006 (GB) 0601037.5

(51) Int. Cl. C11D 1/29

(52) U.S. Cl. 510/414; 510/407

(57) ABSTRACT

The present invention is directed to an acidic hard surface treatment composition which provides a cleaning benefit comprising: an acidic constituent which comprises water soluble organic acid; at least one anionic surfactant constituent; at least one nonionic surfactant constituent; at least one organic solvent constituent; at least one inorganic chloride salt; optionally one or more further constituents and the balance, water.

The present invention relates to lavatory cleaning compositions which feature improved cleaning of metallic surfaces.

Cleaning compositions are commercially important products and enjoy a wide field of utility in assisting in the removal of dirt and grime from surfaces, especially those characterized as useful with “hard surfaces”. Hard surfaces are those which are frequently encountered in lavatories such as lavatory fixtures such as toilets, shower stalls, bathtubs, bidets, sinks, etc., as well as countertops, walls, floors, etc.

The prior art has suggested many compositions which are directed to the cleaning of such hard water and soap scum stains. (“Soap scum” is sometimes referred to as “limescale” in Europe.) Many of these are acidic, aqueous compositions which include one or more detersive surfactants. A limited number of these compositions, in addition to a detersive benefit, also provide a germicidal or sanitizing effect to the hard surfaces being treated, often due to the inclusion of one or more antimicrobial constituents, such as known cationic quaternary ammonium compounds which are known to be effective against gram positive type pathogenic bacteria such as Staphylococcus aureus, and/or gram negative type pathogenic bacteria such as Salmonella choleraesuis and/or Pseudomonas aeruginosa, or other known-art antimicrobial constituents such as non-cationic phenolic based antimicrobials e.g., mono- and poly-alkyl and aromatic halophenols; para-chloro-meta-xylenol; resorcinol and derivatives thereof; bisphenolic compounds such as 2,2′-methylene bis-(4-chloro-6-bromophenol); halogenated carbanilides such as 3,4,4′-trichlorocarbanilides (Triclocarban); 2-hydroxydiphenyl compounds such as Triclosan; parabens such as propylparaben; pyrithiones; hydantoin compounds such as dimethyldimethylol hydantoin; iodophors and in some cases, bleach. However the inclusion of such antimicrobial constituents is often not without one or more detriments including but not limited to specific formulation limitations, toxicity concerns, and the like.

Accordingly, there is a real and continuing need in the art for improved hard surface treatment compositions which provide a cleaning benefit or disinfecting benefit, (preferably both) and which overcomes one or more of the shortcomings of prior art hard surface cleaning compositions.

According to the invention, there is provided a hard surface treatment compositions which provide a cleaning benefit comprising (preferably also providing a disinfecting or sanitizing benefit) an acidic constituent which comprises (preferably consists essentially of) an acid constituent which may be an inorganic, mineral or organic acid in particular one or more organic acids selected from the group consisting of: citric acid, sorbic acid, acetic acid, boric acid, formic acid, maleic acid, adipic acid, lactic acid, malic acid, malonic acid, glycolic acid, and mixtures thereof; at least one anionic surfactant constituent; at least one nonionic surfactant constituent; at least one organic solvent constituent; and at least one inorganic chloride salt in an amount effective to provide improved cleaning of metal surfaces, particularly copper surfaces, and optionally one or more further constituents selected from coloring agents, fragrances and fragrance solubilizers, viscosity modifying agents, pH adjusting agents and pH buffers including organic and inorganic salts, optical brighteners, opacifying agents, hydrotropes, antifoaming agents, enzymes, anti-spotting agents, anti-oxidants, preservatives, and anti-corrosion agents; and the balance, water.

According to certain preferred embodiments of the invention, the inventors expect that the inclusion of modest amounts of the specific water soluble organic acids in conjunction with the specific surfactants in the largely aqueous compositions will provide a satisfactory antimicrobial effect to the hard surfaces treated with the largely aqueous compositions of the invention. This is particularly surprising as such preferred embodiments of the inventive compositions specifically exclude known cationic quaternary ammonium compounds which are known to be effective against gram positive and/or gram negative pathogenic bacteria, as well as excluding other known-art antimicrobial constituents such as non-cationic phenolic based antimicrobials e.g., mono- and poly-alkyl and aromatic halophenols; para-chloro-meta-xylenol; resorcinol and derivatives thereof; bisphenolic compounds such as 2,2′-methylene bis-(4-chloro-6-bromophenol); halogenated carbanilides such as 3,4,4′-trichlorocarbanilides (Triclocarban); 2-hydroxydiphenyl compounds such as Triclosan; parabens such as propylparaben; pyrithiones; hydantoin compounds such as dimethyldimethylol hydantoin; iodophors and also, bleach. The inventive compositions are also expected to have a low potential for irritation as well as low toxicity levels due to the absence of these aforesaid known cationic quaternary ammonium compounds and other known-art antimicrobial constituents.

Certain particularly preferred embodiments of the invention are directed to compositions which provide a cleaning and disinfecting benefit.

Other particularly preferred embodiments of the invention are directed to compositions which provide a cleaning benefit, but which do not necessarily provide a disinfecting benefit.

The present inventive compositions necessarily comprise an acid constituent which be a water soluble inorganic acid, mineral acid, or a water soluble organic acids. By way of non-limiting example useful inorganic acids include hydrochloric acid, phosphoric acid, sulfuric acid acid. With respect to water soluble organic acids, generally include at least one carbon atom, and include at least one carboxyl group (—COOH) in its structure. Preferred are water soluble organic acids which contain from 1 to about 6 carbon atoms, and at least one carboxyl group as noted. Preferred as the acid constituent are one or more organic acids selected from the group consisting of: citric acid, sorbic acid, acetic acid, boric acid, formic acid, maleic acid, adipic acid, lactic acid, malic acid, malonic acid, glycolic acid, and mixtures thereof. Each of these acids are water soluble, and comprises as least one carboxyl group (—COOH) in its structure. Desirably the organic acid constituent comprises citric acid and optionally one or more further of the recited organic acids, and in certain particularly preferred embodiments the organic acid constituent consists essentially of, preferably consists solely of citric acid. The acid constituent may be present in any effective amount, but desirably is not present in amounts of more than about 10% wt. based on the total weight of the compositions (generally from about 0.1 to about 10% wt.). Further, the amount of acid present in the composition, keeping in mind any optional ingredients that may be present, should be in an amount such that the pH of the composition is less than 6, preferably from about 5.0 to about 1.0, more preferably from about 4.0 to about 1.0, and even more preferably from about 3.0 to about 1.0. Particularly preferred organic acid constituents and particularly preferred amounts are described with reference to one or more of the Examples.

A further essential constituent of the present inventive compositions is an anionic surfactant constituent which comprises one or more anionic surfactants. Suitable anionic surfactants include, for example, alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds comprise a carbon chain containing 12 to 20 carbon atoms. Examples of the foregoing anionic surfactants are available under the following tradenames: RHODAPON, STEPANOL, HOSTAPUR, SURFINE, SANDOPAN, NEODOX, BIOSOFT, and AVANEL.

The anionic surfactant constituent forms from about 0.1 to about 10% by weight. Particularly preferred anionic surfactant constituents and weight percentages thereof are described with reference to one or more of the Examples.

A further essential constituent of the present inventive compositions is a nonionic surfactant constituent which comprises one or more nonionic surfactants. Nonlimiting examples of suitable nonionic surfactants which may be used in the present invention are as follows:

(1) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

(2) The condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. Examples include Alfonic® 810-4.5 (also available as Teric G9A5), which is described in product literature from Sasol as a C₈₋₁₀ having an average molecular weight of 356, an ethylene oxide content of about 4.85 moles (about 60 wt. %), and an HLB of about 12; Alfonic® 810-2, which is described in product literature from Sasol as a C₈₋₁₀ having an average molecular weight of 242, an ethylene oxide content of about 2.1 moles (about 40 wt. %), and an HLB of about 12; and Alfonic® 610-3.5, which is described in product literature from Sasol as having an average molecular weight of 276, an ethylene oxide content of about 3.1 moles (about 50 wt. %), and an HLB of 10. Product literature from Sasol also identifies that the numbers in the alcohol ethoxylate name designate the carbon chain length (numbers before the hyphen) and the average moles of ethylene oxide (numbers after the hyphen) in the product.

Further examples of useful nonionic surfactants include alcohol ethoxylates including C₁₀ oxo-alcohol ethoxylates available from BASF under the Lutensol ON tradename. They are available in grades containing from about 3 to about 11 moles of ethylene oxide (available under the names Lutensol ON 30; Lutensol ON 50; Lutensol ON 60; Lutensol ON 65; Lutensol ON 66; Lutensol ON 70; Lutensol ON 80; and Lutensol ON 110). Yet further examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Still further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9; —where R is linear C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol UD series from Clariant, described as tradenames Genapol UD 030, C₁₁-Oxo-alcohol polyglycol ether with 3 EO; Genapol UD, 050 C₁₁-Oxo-alcohol polyglycol ether with 5 EO; Genapol UD 070, C₁-Oxo-alcohol polyglycol ether with 7 EO; Genapol UD 080, C₁₁-Oxo-alcohol polyglycol ether with 8 EO; Genapol UD 088, C₁₁-Oxo-alcohol polyglycol ether with 8 EO; and Genapol UD 110, C₁₁-Oxo-alcohol polyglycol ether with 11 EO.

Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename. available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₋₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

(3) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where
EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants appropriate for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein
R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein
n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

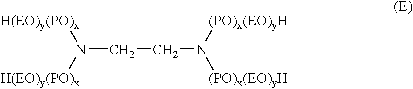

where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

The nonionic surfactant is present in the compositions of the present invention in an amount of from about 0.1 to about 10% by weight. Particularly preferred nonionic surfactant is constituents and weight percentages are described with reference to one or more of the Examples.

A further necessary constituent of the inventive compositions is an organic solvent constituent which comprise one or more organic solvents. Examples of organic solvents which may be included in the inventive compositions include those which are at least partially water-miscible such as alcohols (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g. propylene glycol monomethyl ether acetate), and mixtures thereof. Glycol ethers having the general structure Rₐ—R_{b}—OH, wherein Rₐ is an alkoxy of 1 to 20 carbon atoms, or aryloxy of at least 6 carbon atoms, and R_{b} is an ether condensate of propylene glycol and/or ethylene glycol having from one to ten glycol monomer units.

Preferably the organic solvent constituent consists essentially of an alcohol and a water miscible glycol ether to the exclusion of other organic solvents. More preferably the organic solvent constituent consists solely of one or more organic solvents selected from ethanol, dipropylene glycol n-propyl ether and mixtures thereof and most desirably the organic solvent constituent consists solely of a mixture of ethanol and dipropylene glycol n-propyl ether. While not wishing to be bound by the following, the present inventors suspect that this pair of specific solvents may favorably affect the disruption of the cell walls of undesired microorganisms which may facilitate in their demise.

The organic solvent is present in the compositions of the present invention in an amount of from about 0.1 to about 10% by weight, desirably in amounts of 1.0 to about 7.0% by weight, and most desirably from about 1.0 to about 5.0% weight. Particularly preferred organic solvent constituents and weigh percentages thereof are described with reference to one or more of the Examples.

A further essential constituent of the invention is at least one inorganic chloride salt. The inorganic chloride salt is desirably present in an amount effective to provide improved cleaning of metal surfaces, particularly copper surfaces which are immersed or contacted with the inventive compositions. The inorganic chloride salt(s) used in the compositions of the present invention can be any water-soluble inorganic chloride salt or mixtures of such salts. For purposes of the present invention, “water-soluble” means having a solubility in water of at least 10 grams per hundred grams of water at 20° C. Examples of suitable salts include various alkali metal and/or alkaline earth metal chlorides including sodium chloride, calcium chloride, magnesium chloride and zinc chloride. Particularly preferred are sodium chloride and calcium chloride which have been surprisingly observed to provide excellent metal cleaning efficacy particularly of aged copper surfaces. The inorganic chloride salt(s) is present in the compositions of the present invention in an amount which will provide an improved cleaning of metal surfaces, particularly copper surfaces, compared to an identical composition which excludes the inorganic chloride salts(s). Preferably the inorganic chloride salt(s) are present in amounts of from about 0.00001 to about 3% by weight, desirably in amounts of 0.001 to about 2.5% by weight, yet more desirably from about 0.01 to about 1.5% by weight and most desirably from about 0.2 to about 1.5% weight. Particularly preferred inorganic chloride salt(s) and weight percentages thereof are described with reference to one or more of the Examples.

The inventors have unexpectedly discovered that sulfate salts do not provide improved cleaning of metal surfaces this function, and the inventors do not expect that other non-chloride alkali metal and/or alkaline earth metal salts, e.g. those based on borates, bromides, fluorides, phosphates, carbonates, bicarbonates, citrates, acetates, lactates, provide such an improved metal cleaning function. In certain preferred embodiments the sole inorganic salts present are one or more inorganic chloride salts.

The compositions are largely aqueous in nature, and comprises as the balance of the composition water in to order to provide to 100% by weight of the compositions of the invention. The water may be tap water, but is preferably distilled and is most preferably deionized water. If the water is tap water, it is preferably substantially free of any undesirable impurities such as organics or inorganics, especially mineral salts which are present in hard water which may thus undesirably interfere with the operation of the constituents present in the aqueous compositions according to the invention. As the composition is predominantly aqueous, the compositions comprise at least 82% wt, water, preferably at least 85% wt. water, most preferably at least about 87.5% wt. water.

The composition of the present invention can optionally comprise one or more constituents selected from coloring agents, fragrances and fragrance solubilizers, viscosity modifying agents, other surfactants, pH adjusting agents and pH buffers including organic and inorganic salts, optical brighteners, opacifying agents, hydrotropes, antifoaming agents, enzymes, anti-spotting agents, anti-oxidants, preservatives, and anti-corrosion agents. The use and selection of these constituents is well known to those of ordinary skill in the art. The total amounts of such optional additives is less than about 2% wt. but are desirably significantly less, such as less than about 0.5% wt. based on the total weight of the composition being provided herein.

The benefits of the compositions described in this specification include particularly: good removal of hard water stains, good removal of soap scum stains, relatively low toxicity, as well as ease in handling of the composition due to its readily pourable or pumpable characteristic, and when needed, disinfection. Further, when one or more of the optional constituents is added, i.e., fragrance and/or coloring agents, the esthetic and consumer appeal of the product is favorably improved.

The compositions according to the invention are useful in the cleaning and/or disinfecting of hard surfaces, having deposited soil thereon. In such a process, cleaning and disinfecting of such surfaces comprises the step of applying a stain releasing and/or a disinfecting effective amount of a composition as taught herein to such a stained surface. Afterwards, the compositions are optionally but desirably wiped, scrubbed or otherwise physically contacted with the hard surface, and further optionally, may be subsequently rinsed from the surface.

Exemplary hard surfaces which may be treated utilizing the inventive compositions include surfaces composed of refractory materials such as: glazed and unglazed tile, brick, porcelain, ceramics as well as stone including marble, granite, and other stones surfaces; glass; metals; plastics e.g. polyester, vinyl; fiberglass, Formica®, Corian® and other hard surfaces known to the industry. Hard surfaces which are to be particularly denoted are lavatory fixtures such as shower stalls, bathtubs and bathing appliances (racks, curtains, shower doors, shower bars) toilets, bidets, wall and flooring surfaces especially those which include refractory materials and the like. Further hard surfaces which are to be denoted are those associated with kitchen environments and other environments associated with food preparation, including cabinets and countertop surfaces as well as walls and floor surfaces especially those which include refractory materials, plastics, Formica®, Corian® and stone. Such hard surfaces described above are to be understood as being recited by way of illustration and not be way of limitation. As noted previously the composition is particularly effective in the cleaning of metal and metallic surfaces. Such surfaces are commonly encountered in lavatory environments, e.g., lavatory fixtures, as well as kitchen environments, e.g, cookware, utensils, dishware and the like. The compositions also find use in the cleaning of metal surfaces upon or within the interior of kitchen and lavatory appliances, e.g. in the cleaning of metal surfaces on kitchen appliances, including but not limited to polished, chromed, burnished or so called “brushed” or matte metal surfaces such as on kitchen countertops, appliance housings, appliance surfaces including exterior surfaces such as doors, as well as interior surfaces such as the interior spaces of dishwashers, ovens, kitchen ranges and the like. In preferred embodiments the inventive compositions provide excellent cleaning benefits and also surprisingly provide improved cleaning and reduction of stains, tarnish or other metal discoloration, e.g., as may be caused by the buildup of dirt, grease, and the like or metal oxidation of treated metal surfaces. This effect is most pronounced on copper surfaces, however it is to be understood that the inventive compositions find use in the cleaning treatment of all metal surfaces as may be encountered in such environments. By way of non-limiting example such metals include aluminum, copper, steel, stainless steel, brass, metal alloys which may include one or more of the former metals, as well as chromed metal and non-metal substrates which have a metal or metallized surface.

The cleaning compositions provided according to the invention can be desirably provided as a ready to use product in a pourable, manually squeezed bottle (deformable bottle), or spray bottle which uses a dip tube and trigger assembly to dispense a liquid In such an application, the consumer generally applies an effective amount of the cleaning composition and within a few moments thereafter, wipes off the treated area with a rag, towel, brush or sponge, usually a disposable paper towel or sponge. In certain applications, however, especially where undesirable stain deposits are heavy, the cleaning composition according to the invention may be left on the stained area until it has effectively loosened the stain deposits after which it may then be wiped off, rinsed off, or otherwise removed. For particularly heavy deposits of such undesired stains, multiple applications may also be used.

The following examples below illustrate exemplary formulations and preferred formulations of the inventive composition. It is to be understood that these examples are presented by means of illustration only and that further useful formulations fall within the scope of this invention and the claims may be readily produced by one skilled in the art and not deviate from the scope and spirit of the invention. Throughout this specification and in the accompanying claims, weight percents of any constituent are to be understood as the weight percent of the active portion of the referenced constituent, unless otherwise indicated.

### EXAMPLES

### Preparation of Example Formulations

Exemplary formulations illustrating certain preferred embodiments of the inventive compositions and described in more detail in Table I below were formulated generally in accordance with the following protocol.

Into a suitably sized vessel, a measured amount of water was provided after which the constituents were added in the following sequence: thickening agents, surfactant, acid and then the remaining constituents. Mixing, which generally lasted from 5 minutes to 60 minutes was maintained until the particular formulation appeared to be homogeneous. The exemplary compositions were readily pourable, and retained well mixed characteristics (i.e., stable mixtures) upon standing. The constituents may be added in any order.

Examples of inventive formulations, “E1” through “E4” including certain particularly preferred formulations are shown in Table 1 below (unless otherwise stated, the components are at 100% active). To each of the compositions was added deionized water in “quantum sufficient” (q.s.) in order to provide 100 parts by weight of the specific composition. Two comparative examples “C2” and “C3” was also produced, one of which did not include any inorganic salts, the other which included an inorganic sulfate salt.

TABLE 1

| Constituent: | E1 | C1 | E2 | E3 | E4 | C2 |
|---|---|---|---|---|---|---|
| HOSTAPUR SAS 30* (30%) | 9.16 | 9.16 | 9.16 | 9.16 | 9.16 | 9.16 |
| LUTENSOL ON50** | 1.0 | 1.0 | 1.0 | 1.0 | 1.0 | 1.0 |
| denatured ethanol (95%) | 1.05 | 1.05 | 1.05 | 1.05 | 1.05 | 1.05 |
| anhydrous citric acid | 3.5 | 3.5 | 3.5 | 3.5 | 3.5 | 3.5 |
| sodium chloride | 1.0 | — | — | — | — | — |
| sodium sulfate | — | 1.0 | — | — | — | — |
| calcium chloride | — | — | 1.0 | — | — | — |
| magnesium chloride (6H₂O) | — | — | — | 2.14 | — | — |
| zinc chloride | — | — | — | — | 1.0 | — |

*described by its supplier to be a C₁₄₋₁₇ secondary sulfonate sodium salt; 30% wt. active (ex. Clariant Inc.)
**described by its supplier to be a C₁₀-oxoalkohol with 5 EO, 100% wt. active (ex. BASF)

The compositions of Table 1 were subjected to several tests to evaluate the ability of the compositions to clean soiled copper metal surfaces.

To the test was performed utilizing a number of equally soiled, weathered U.S. currency (pennies) which would initially visually observed and judged to be uniformly soiled.

Each of the pennies were immersed for intervals of 15, 30, or 60 seconds in each of the compositions described on foregoing Table 1 at the end of their immersion were quickly removed and dried. No mechanical abrasion or scrubbing the was applied to the metal surface before, during pick, or after the immersion tests. Afterwards, the degree of cleaning efficacy was judged on a scale of “0” to “5”, with no visually observed cleaning of the penny to the judged as a “0” score, and within the maximum cleaning to a shiny brightness being a established as the highest end of the scale and being rated a “5”. The results of the cleaning test are disclosed on the following table.

TABLE
Copper Cleaning

| Immersion | | | | | | |
|---|---|---|---|---|---|---|
| Time: | E1 | C1 | E2 | E3 | E4 | C2 |
| 15 seconds | 3.0 | 0.0 | 0.0 | 0.5 | 1.0 | 0.0 |
| 30 seconds | 3.5 | 0.0 | 1.5 | 0.5 | 1.5 | 0.0 |
| 60 seconds | 4.0 | 1.0 | 2.5 | 2.0 | 1.5 | 1.5 |

As can be understood from a review of the results disclosed on the table, the compositions comprising inorganic chloride salts were observed to be better performing in this cleaning of the copper surface than other inorganic salts, namely the inorganic sulfate salts. Of these, it was observed at that sodium chloride was apparently the best performing of the inorganic salts used in the formulations.

While not wishing to be bound by the following, it is hypothesized by the inventors that most metal oxides particularly copper oxide show some degree of solubility and an acidic medium and the presence of the preferred inorganic acid, citric acid, and the example formulations exhibit synergistically improved dissolution of any surface oxide layer on the coin after, or during the simultaneous cleaning of any inorganic soils or organic soils which were present on the surface of each of the coins prior to the initiation of the test. It is nonetheless surprising to see that the inclusion on the inorganic salts provided an approximate three-fold improvement in the metal cleaning performance as is evident from a comparison of the results disclosed for the example composition E1 and the very similar comparative composition C1 which however did not include any inorganic chloride salts. It is also concurrently surprising to note that the compositions provide good storage stability notwithstanding the amounts of the inorganic salts present in their formulations.

The composition according to E1 described on the foregoing Table 1 was also evaluated against a competitive commercial product, AJAX “Universal” Cleaner (ex. Colgate-Palmolive Co.) to evaluate cleaning efficacy against soap scum deposits, rust and on a standardized soil. The AJAX “Universal” Cleaner was used as supplied from its manufacturer without dilution.

### Soap Scum Removal Evaluation:

The soap scum removal characteristics of certain example formulations described on Table 1 were evaluated, as well that of several commercially available consumer products which were used as comparative examples. The test is generally in accordance with the protocols outlined in CSMA Designation DCC-16 (May 1995).

This test is described generally as follows:

First, a “parent” soil is made, based on the following formulation:

| “Parent” soil | % w/w |
|---|---|
| bar soap | 3.90 |
| shampoo | 0.35 |
| clay | 0.06 |
| artificial sebum | 0.15 |
| hard water | 95.54 |

The parent soil was produced according to the following steps: First, the bar soap was shaved into a suitable beaker, after the remaining constituents, were added in the order given above and stirred with three-blade propeller mixer. Next, the contents of the beaker was heated to 45-50° C. and mixed using a motorized three-blade propeller mixer until a smooth, lump-free suspension is achieved. This usually required about two hours with moderate agitation. Subsequently, the contents of the beaker were filtered through a Buchner funnel fitted with Whatman #1 filter paper or equivalent. The filtrate was then resuspended in clean, deionized water, using the same amount of water used to make the soil, and this was filtered again. The (re-filtered) filtrate was uniformly dried overnight at 45° C. to form a filter cake. Thereafter, the filter cake was pulverized and was suitable for immediate use, or may be stored in a sealed container for up to six months.

As test substrates, 4¼ inch by 4¼ inch black ceramic bathroom tiles were used. Each of the tiles as thoroughly washed (using a commercially available hand dishwashing detergent) and rinsed, then washed with isopropyl alcohol. The washed tiles were then permitted to dry overnight at room temperature. Each tile was then weighed, and the mass recorded.

In preparation for supplying the tiles with an amount of the test soil, a test soil was prepared based on the following formulation:

| Test soil: | % w/w |
|---|---|
| “parent” soil | 4.50 |
| hard water | 9.0 |
| hydrochloric acid (0.1N) | 0.77 |
| acetone | 85.73 |

The test soil was produced according to the following steps: The constituents indicated were introduced into a clean beaker, with the acetone being added prior to the water, and the ‘parent’ soil being added last. The contents of the beaker were mixed using a standard three blade laboratory mixed until the contents formed a uniform mixture, and the color changed from white to gray. This typically required 20-40 minutes, during which time the beaker should have been covered as much as possible to avoid excessive solvent loss. Next, a suitable quantity of the contents of the test soil from the beaker were provided to an artist's airbrush while the beaker was swirled to ensure a soil uniformity. (If testing required more than one day, a fresh amount of test soil was prepared daily and used for that day's testing.)

Soil was applied to a number of clean, dry tiles may be placed into rows and columns in preparation for depositing of the test soil. The airbrush was operated at 40 psi, and the test soil was sprayed to provide a visually uniform amount of soil onto the tiles. (Uniform soil suspension during application was maintained by continuous brush motion and/or swirling of test soil in the airbrush.) In this manner, approximately 0.10 g-0.12 g of the test soil were applied per tile. Subsequently each of the coated tiles were then allowed to air dry for approximately 30 minutes. Thereafter each tile was placed in a laboratory oven having a temperature of 205° C. for 30 minutes to further treat the coated tiles. Subsequently the tiles were removed and permitted to cool to room temperature.

To evaluate cleaning, 2 tiles were treated with each tested composition in order to evaluate its efficacy in removing soap scum from the prepared tile substrates. In the test, prepared tile substrates were secured within a Gardner Abrasion Tester, and thereafter 2 grams of a test composition was applied by pipetting to the soiled surface of a tile, which was allowed to stand for 30 seconds. Thereafter the a Gardner Abrasion Tester was cycled 10 times with a clean moistened sponge, and then the tile was immediately removed and rinsed in a stream of cold running tap water for 20-30 seconds. Subsequently, the rinsed tile was allowed to dry at room temperature in a rack which stood the tile on one side thereof.

The dried tested tile was then evaluated using a Tri-Gloss meter at 60 degrees, and 16 readings were taken at randomly selected points of the cleaned surface in order to determine surface reflectance. According to the reflective means, the percentage of soap scum removal from each tile was determined utilizing the following equation:

$$\% Removal = \frac{RC - RS}{RO - RS} \times 100$$

where

RC=Reflectance of tile after cleaning with test product

RO=Reflectance of original soiled tile

RS=Reflectance of soiled tile

The results of this evaluation was averaged for each of the tested compositions, and the results of the evaluation are reported on the following table.

| Product or composition | % soap scum removal |
|---|---|
| E1 | 72.90 |
| AJAX Universal Cleaner | 63.31 |

The reported results illustrate that compositions according to the present invention exhibited soap scum removal efficacy superior to the tested commercially available cleaning product.

### Rust Removal Evaluation:

The compositions of E1 and the commercial product, AJAX Universal Cleaner were evaluated for their efficacy in the removal of rust stains from hard surfaces generally in accordance with the following protocol.

A standardized test soil was prepared by combining 98% wt. deionized water at room temperature with 2% ferric chloride which was mixed until a uniform soil composition was formed.

As substrates, a series of standard white 4¼ inch square ceramic tiles were used. The white surfaces of the tiles were cleaned with isopropanol and dried overnight at room temperature. The reflectance reading of each of the tiles was evaluated using a Minolta Reflectometer CR-231.

Next, the dried tiles were placed on a flat surface, and using a fine mist sprayer an even coating of the uniform soil composition was applied to the exposed surfaces of the tile. Immediately after this application, a stream of heated air provided by a laboratory grade blow dryer was passed over the coated surfaces until a light brown color was observed on each of the tiles. Subsequently a 1% NaOH aqueous solution was applied to the dried tile surfaces using a fine mist sprayer and again, thereafter the file surfaces were dried by using the laboratory grade blow dryer as noted above. The tiles were then allowed to cool to the touch, and then each was rinsed under a stream of tap water and then again dried by using the laboratory grade blow dryer as noted above. The reflectance reading of the each of the prepared, soiled tiles was again evaluated

To evaluate rust removal efficacy, 2 grams of each test composition was applied by pipetting to the soiled surface of a tile, and allowed to stand for 10 minutes. Thereafter the tile was rinsed in a stream of cold tap water for 10 15 seconds, then the tile was placed in a Gardner Abrasion Tester and secured. A moistened sponge was placed in the holder of the Tester, and the device was cycled once. Thereafter the tile was removed and the surface reflectance, an indicator of the rust removal efficacy of the tested composition was evaluated a Minolta Reflectometer CR-231 in order to determine the change in reflectance between the original reflectance value of the soiled bathroom tile, and the reflectance of a soiled tile which was cleaned using a quantity of a tested composition in accordance with the test protocol described above. According to the reflective means, the percentage of rust removal was determined utilizing the following equation:

$$\% Removal = \frac{RC - RS}{RO - RS} \times 100$$

where

RC=Reflectance of tile after cleaning with test product

RO=Reflectance of original soiled tile

RS=Reflectance of soiled tile

For each tile, three readings were taken and the results averaged to provide a median reading for each tile. Two tiles were used to evaluate each of the tested compositions and the average reading for each tile, as well as the averaged reflectance reading for both tiles treated using a particular test composition is reported on the following table.

| Product or composition | % rust removed |
|---|---|
| E1 | 14.63 |
| AJAX Universal Cleaner | 13.18 |

From the foregoing, it can be seen that the compositions according to the present invention provided effective rust removal performance to the known art, commercially available cleaning product.

### Cleaning Evaluation

The compositions of E1 and the commercial product, AJAX Universal Cleaner were evaluated for their efficacy in the removal of rust stains from hard surfaces generally in accordance with the following protocol.

Cleaning evaluations were performed in accordance with the testing protocol outlined according to ASTM D4488 A2 Test Method, which evaluated the efficacy of the cleaning compositions in removing greasy soil on masonite wallboard samples painted with wall paint. The soil applied was a greasy soil sample containing:

| Test Greasy Soil | % w/w |
|---|---|
| Vegetable oil | 33 |
| Vegetable shortening | 33 |
| Lard | 33 |
| Carbon black | 1 |

which were blended together to homogeneity under gentle heating to form a uniform mixture which was later allowed to cool to room temperature. The sponge (water dampened) of a Gardner Abrasion Tester apparatus was squirted with a 15 gram sample of a tested cleaning composition, and the apparatus was cycled 10 times. The test was replicated 2 times for each tested composition. The tiles were dried, and then the cleaning efficacy was evaluated.

Each dried tested tiles was evaluated using a Tri-Gloss meter at 60 degrees, and 3 readings were taken at randomly selected points of the cleaned surface in order to determine surface reflectance. According to the reflective means, the percentage of soap scum removal from each tile was determined utilizing the following equation:

$$\% Removal = \frac{RC - RS}{RO - RS} \times 100$$

where

RC=Reflectance of tile after cleaning with test product

RO=Reflectance of original soiled tile

RS=Reflectance of soiled tile

The results of this evaluation was averaged for each of the tested compositions, and the results of the evaluation are reported on the following table.

| Product or composition | % soil removed (mean value) |
|---|---|
| E1 | 91.62 |
| AJAX Universal Cleaner | 98.04 |

From the foregoing, it can be seen that the compositions according to the present invention provided comparable cleaning performance to the known art, commercially available cleaning product.

All of the above formulations according to the examples (E1 through E5) are expected to have good cleaning properties, including good cleaning efficacy of hard surfaces and particularly good cleaning efficacy of metal and metallic surfaces.

Certain particularly preferred compositions of the invention also provide an effective disinfecting benefit against one or more of against Staphylococcus aureus (gram positive type pathogenic bacteria) (ATCC 6538), Salmonella choleraesuis (gram negative type pathogenic bacteria) (ATCC 10708), Escheria coli (gram negative type pathogenic bacteria) (ATCC 11229) and Pseudomonas aeruginosa (ATCC 15442).

1. A hard surface treatment composition which provides a cleaning and optionally a disinfecting benefit comprising:
an acidic constituent;
at least one anionic surfactant constituent;
at least one nonionic surfactant constituent;
at least one organic solvent constituent;
at least one inorganic chloride salt;
optionally one or more further constituents selected from coloring agents, fragrances and fragrance solubilizers, viscosity modifying agents, pH adjusting agents and pH buffers including organic and inorganic salts, optical brighteners, opacifying agents, hydrotropes, antifoaming agents, enzymes, anti-spotting agents, anti-oxidants, preservatives, and anti-corrosion agents;
and the balance, water.

2. A composition according to claim 1 wherein the acid constituent consists essentially of an organic acid selected from the group consisting of: citric acid, sorbic acid, acetic acid, boric acid, formic acid, maleic acid, adipic acid, lactic acid, malic acid, malonic acid, glycolic acid, and mixtures thereof.

3. A composition according to claim 1 wherein the organic solvent is selected from alcohols, glycols, water miscible ethers, water miscible glycol ethers, monalkylether esters, and mixtures thereof.

4. The composition according to claim 1 wherein the organic solvent is selected from alcohols, water miscible glycol ethers and mixtures thereof.

5. A composition according to claim 1 wherein the organic solvent is an alcohol.

6. A composition according to claim 1 wherein the organic solvent is ethanol.

7. A composition according to claim 1 wherein the pH is from about 1 to about 5.

8. A composition according to claim 1 wherein the pH is from about 1 to 4.

9. A composition according to claim 1 wherein the pH is from about 1 to about 3.

10. A composition according to claim 4 wherein the organic solvent is a mixture of alcohol and a water miscible glycol ether.

11. A composition according to claim 10 wherein the organic solvent is mixture of ethanol and water miscible glycol ether.

12. A composition according to claim 1 wherein the pH is from about 1 to about 5.

13. A composition according to claim 1 wherein the pH is from about 1 to 4.

14. A composition according to claim 1 wherein the pH is from about 1 to about 3.

15. A composition according to claim 1 wherein the anionic surfactant is a sulfonate.

16. A composition according to claim 1 wherein known cationic quaternary ammonium compounds known to be effective against gram positive and/or gram negative type pathogenic bacteria, other known-art antimicrobial constituents including as non-cationic phenolic based antimicrobials e.g., mono- and poly-alkyl and aromatic halophenols; para-chloro-meta-xylenol; resorcinol and derivatives thereof; bisphenolic compounds such as 2,2′-methylene bis-(4-chloro-6-bromophenol); halogenated carbanilides such as 3,4,4′-trichlorocarbanilides (Triclocarban); 2-hydroxydiphenyl compounds such as Triclosan; parabens such as propylparaben; pyrithiones; hydantoin compounds such as dimethyldimethylol hydantoin; iodophors and bleach are excluded.

17. A composition according to claim 1 substantially as described with reference to the Examples.

18. A method of treating a hard surface comprising applying an effective amount of a composition according to claim 1 to the surface in need of treatment.

19. A method of treating a metal or metallic surface comprising applying an effective amount of a composition according to claim 1 to the surface in need of treatment.
